(19) United States
(12) Patent Application Publication
(10) Pub. No.: US 2023/0299269 A1
(43) Pub. Date: Sep. 21, 2023

(54) SILICON-CARBON COMPOSITE FIBER

(71) Applicant: UNIFRAX I LLC, Tonawanda, NY (US)

(72) Inventors: Donghui ZHAO, Amherst, NY (US); Wenbo CHENG, Getzville, NY (US)

(21) Appl. No.: 18/189,700

(22) Filed: Mar. 24, 2023

Related U.S. Application Data
(63) Continuation of application No. PCT/US2023/064763, filed on Mar. 21, 2023.
(60) Provisional application No. 63/269,652, filed on Mar. 21, 2022.

(51) Int. Cl. H01M 4/36; H01M 4/38; H01M 4/583; H01M 4/04

(52) U.S. Cl. CPC H01M 4/364; H01M 4/386; H01M 4/583; H01M 4/0471; H01M 4/0421; H01M 2004/021

(57) ABSTRACT

A composite fiber includes a porous silicon phase including elemental silicon and a porous carbon phase including elemental carbon. The silicon phase and the carbon phase form an intertwined network structure in the composite fiber such that each of the silicon phase and the carbon phase is interconnected and continuous throughout the composite fiber. The silicon phase and the carbon phase together constitute at least 50 percent by weight of the composite fiber.

### CROSS-REFERENCE TO RELATED APPLICATIONS

This application is a continuation of PCT International Patent Application No. PCT/US2023/064763, filed Mar. 21, 2023, which claims benefit of U.S. Provisional Patent Application No. 63/269,652, filed Mar. 21, 2022, which are incorporated herein by reference in their entirety.

### FIELD OF THE DISCLOSURE

The present disclosure relates to a silicon-carbon composite fiber and methods of making and using the same.

### BACKGROUND

Lithium-ion batteries have proliferated in the last decade and now are the power source of choice for providing portable power to electronic devices, cordless equipment, and vehicles. As technology has become increasingly reliant on lithium-ion battery power, the lithium-ion battery industry has worked to extend the performance of their cells in order to provide maximum versatility to the end user.

Graphite is commonly used in lithium-ion cells, due to its ability to remain stable and serve its function over multiple hundreds of cycles with little to no capacity loss. Silicon shows great promise as an anode material, due to its extremely high capacity (4000 mAh/g) relative to graphite (372 mAh/g), which is the current industry standard. However, silicon has the limitation of swelling 350% upon lithiation. This swelling can cause severe disruption of the internal cell structure and result in rapid loss of capacity as cell components are damaged and the anode grinds itself into smaller pieces and ultimately loses electrical connectivity. Thus, there is a continuing need for improved silicon-containing anode materials and methods of preparing such silicon-containing anode materials.

### BRIEF DESCRIPTION OF THE DRAWINGS

Various embodiments of the present disclosure will be understood more fully from the detailed description given below and from the accompanying drawings. In the drawings, like reference numbers may indicate identical or functionally similar elements. Embodiments are described in detail hereinafter with reference to the accompanying figures, in which:

FIG. 1 is a graph summarizing results from Example 1.

FIG. 2 is a graph summarizing results from Example 1.

FIG. 3 is a graph summarizing results from Example 2.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Composite Fiber

The present disclosure provides a silicon-carbon composite fiber comprising a silicon phase (“Si phase”) and a carbon phase (“C phase”). The Si and C phases form an intertwined network structure in the fiber, where each of the phases is interconnected and continuous throughout the fiber. The Si phase comprises nano-crystalline or amorphous elemental silicon. The Si phase is present in the fiber in a range of greater than 0 wt % to less than 100 wt %. The C phase comprises amorphous or crystalline carbon and is present in the fiber in a range of greater than 0 wt % to less than 100 wt %. In some embodiments, the sum of the Si and C phases is in the range of 50 wt % to 100 wt %. In some embodiments, the C phase comprises at least 30 wt % of the fiber and/or the Si phase comprises at least 20 wt % of the fiber.

In one or more embodiments, the composite fiber may also contain amorphous or crystalline silicon oxide, SiOₓ (x≤2). The composite may also contain other impurities, such as aluminum (Al), magnesium (Mg), chlorine (Cl), sodium (Na), nitrogen (N), carbon oxide (COX) (x≤2), and/or hydrocarbon chains. In some embodiments, the composite fiber comprises 5 wt % or less, 4 wt % or less, 3 wt % or less, 2 wt % or less, or 1 wt % or less of Al. In some embodiments, the composite fiber comprises 5 wt % or less, 4 wt % or less, 3 wt % or less, 2 wt % or less, or 1 wt % or less of Mg. In some embodiments, the composite fiber comprises 40 wt % or less, 35 wt % or less, 30 wt % or less, 25 wt % or less, 20 wt % or less, 15 wt % or less, 10 wt % or less, or 5 wt % or less of amorphous or crystalline silicon oxide, SiOₓ (x≤2).

In one or more embodiments, the composite fiber of the present disclosure has a BET specific surface area (“SSA”) of from greater than 0 to 100 m²/g, from 0.1 to 45 m²/g, from 0.1 to 10 m²/g, or from 0.1 to 6 m²/g.

In one or more embodiments, the composite fiber has a pore volume of greater than 0 to 0.3 cm³/g, from 0.01 to 0.3 cm³/g, from greater than 0 to 0.05 cm³/g, from 0.01 to 0.03 cm³/g, from greater than 0 to 0.1 cm³/g, from 0.02 to 0.06 cm³/g, or from 0.05 to 0.25 cm³/g.

In one or more embodiments, the composite fiber has an average pore size of from 5 to 80 nm, from 15 to 55 nm, from 20 to 35 nm, or from 15 to 40 nm.

In one or more embodiments, the composite fiber has an average diameter of from 0.1 to 20 microns, from 0.1 to 10 microns, from 0.5 to 6 microns, from 1 to 8 microns, or from 2 to 5 microns.

In one or more embodiments, the composite fiber has an aspect ratio of fiber length to diameter of at least 3, at least 5, or at least 10.

The nano-crystalline silicon (elemental silicon) of the Si phase may have crystallites having an average size of from 10 to 100 nm, from 15 to 50 nm, from 20 to 45 nm, from 20 to 50 nm, or from 20 to 40 nm. In some embodiments, the Si phase comprises at least 50 wt %, at least 60 wt %, at least 70 wt %, at least 75 wt %, at least 80 wt %, 75 to 90 wt %, or at least 90 wt % of nano-crystalline silicon based on a total weight of the Si phase. In some embodiments, the Si phase comprises at most 50 wt %, at most 40 wt %, at most 30 wt %, at most 20 wt %, or at most 10 wt % of amorphous or crystalline silicon oxide (SiOₓ (x≤2)). In some embodiments, the Si phase consists of nano-crystalline silicon, amorphous silicon, and amorphous or crystalline silicon oxide.

In some embodiments, the Si phase consists of amorphous and crystalline silicon or consists of crystalline silicon. In such embodiments, a silica phase may be present, in which the silica phase consists of amorphous and/or crystalline silicon oxide. The silica phase may be continuous or discontinuous within the composite fiber. For example, the silica phase may form islands within the Si phase and/or the C phase. In some embodiments, a weight ratio between the Si phase and the silica phase within the composite fiber is from 1:1 to 30:1, from 1:1 to 20:1, from 2:1 to 10:1, or from 5:1 to 10:1. In some embodiments, the silica phase is mostly amorphous silica and a weight ratio of amorphous silica to crystalline silica is from greater than 1:1 to 500:1, from 2:1 to 200:1, from 10:1 to 100:1, or from 50:1 to 100:1.

The crystalline silicon is formed of silicon crystallites. Without being bound by theory, it is believed that a silicon crystallite size of at least 10 nm increases the 1st cycle Coulombic efficiency (FCE) of a half-cell including the composite fibers. The FCE measures the amount of capacity that is irreversibly lost during the first cycle of a battery. Minimizing this loss is important as the lost capacity (i.e., spent lithium ions) is carried in the battery as dead weight for the life of the battery. It is believed that the loss is primarily caused by the formation of a solid electrolyte interface (SEI) on surfaces of the active material which traps lithium in the interior of silicon particles. By increasing the size of the silicon crystallites, a smaller portion of lithium ions are consumed during the SEI formation on the surface of silicon crystallites as the specific surface area of the material decreases with the increasing crystallite size.

The C phase may have carbon crystallites ranging in size from 1 to 100 nm, 15 to 50 nm, 1 to 50 nm, or 5 to 20 nm. In some embodiments, the C phase comprises at least 50 wt %, at least 60 wt %, at least 70 wt %, or at least 80 wt % of crystalline carbon based on a total weight of the C phase. In other embodiments, the C phase comprises at most 50 wt %, at most 40 wt %, at most 30 wt %, at most 20 wt %, or at most 10 wt % of crystalline carbon. In some embodiments, the C phase comprises at most 50 wt %, at most 40 wt %, at most 30 wt %, at most 20 wt %, or at most 10 wt % of amorphous carbon. In other embodiments, the C phase comprises at least 50 wt %, at least 60 wt %, at least 70 wt %, or at least 80 wt % of amorphous carbon. In some embodiments, the C phase consists of crystalline carbon and amorphous carbon.

In one or more embodiments, one of the Si phase or the C phase has a crystalline content of greater than 50 wt % while the other of the Si phase or the C phase has a crystalline content of less than 50 wt %, based on the weight of the respective phase. In some embodiments, one of the Si phase or the C phase has a crystalline content of greater than 60 wt % while the other of the Si phase or the C phase has a crystalline content of less than 40 wt %. In some embodiments, one of the Si phase or the C phase has a crystalline content of greater than 70 wt % while the other of the Si phase or the C phase has a crystalline content of less than 30 wt %.

Carbon Precursor Fiber

In some embodiments, the composite fiber is formed by infiltrating a carbon structure with silicon. For example, the composite fiber can be formed by first making a porous carbon fiber, followed by silicon infiltration into the pore structure. The silicon infiltration can be made through a chemical vapor deposition (CVD) process using a silicon precursor gas, such as silane or trichlorosilane. Making the porous carbon fiber may include multiple steps. For instance, first a synthetic polymer fiber may be made with polymers such as polyacrylonitrile (PAN), pitch, rayon, and resin. A carbon fiber may then be made by pyrolyzing the synthetic polymer. In order to make the carbon fiber porous, the carbon fiber may be treated by activation or chemical exfoliation. In an activation method, the porous structure of the carbon fiber is formed by heat treating (e.g., at 700° C. to 1000° C.) the carbon fiber under an oxidizing atmosphere. In the chemical exfoliation method, the carbon fiber may be treated with an exfoliant, such as an acid, and an electric charge may be applied to the fiber. Alternatively, a polymer blend, for example PAN mixed with polymethylmethacrylate (PMMA), may be fiberized into a polymer fiber, which is then oxidized and phase-separated. PMMA may then be removed by pyrolysis, leaving behind a porous carbon fiber.

In some embodiments, the porous carbon fiber, prior to being infiltrated with silicon, comprises at least 50 wt %, at least 60 wt %, at least 70 wt %, or at least 80 wt % of crystalline carbon. The porous carbon fiber may comprise at most 50 wt %, at most 40 wt %, at most 30 wt %, at most 20 wt %, or at most 10 wt % of amorphous carbon. The porous carbon fiber may comprise at most 15 wt %, at most 10 wt %, or at most 5 wt % of impurities (components other than crystalline or amorphous carbon).

Porous Silicon Fiber Template (PSFT)

In some embodiments, the composite fiber is formed by infiltrating a silicon structure with carbon. For example, the composite fiber may be formed by first making a porous silicon fiber template (PSFT) comprising metallic silicon, followed by carbon infiltration into the pores. In order to make the PSFT, a SiO₂-containing fiber, i.e., a precursor fiber, is first made. The precursor fiber can be a silica fiber made by a sol-gel fiberization method, or by acid leaching an oxide glass fiber.

The precursor fiber is reduced to the PSFT comprising metallic silicon by, for example, magnesiothermic reduction. The PSFT is then infiltrated with carbon, for example, through a chemical vapor deposition (CVD) process with a carbonaceous source such as acetylene, or using other deposition processes such as physical vapor deposition, sputtering, atomic layer deposition, or infiltrating the porous fiber first with a hydrocarbon polymer (e.g. resin, polyvinylacetate (PVA)) and converting the polymer into carbon by pyrolysis.

In one or more embodiments, silicon crystallite size within the PSFT may be controlled by the magnesiothermic reduction conditions. In particular, it has been found that greater temperature increases and/or longer exposure to such temperatures tends to form larger silicon crystallites. A heat effect ΔT is characterized by a calculated temperature increase from the exothermic magnesiothermic reduction reaction (i.e., an increase above a firing temperature used to initiate reaction, e.g., around 550 to 600° C.). The magnesiothermic reduction reaction is as follows:

1SiO₂+2Mg→2MgO+1Si

The maximum temperature increase (ΔT) from this reaction can be estimated by:

$$Δ T = \frac{- Δ H \cdot {m}_{Mg}}{2 {M}_{Mg} ( {m}_{Si} {C}_{p , Si} + {m}_{MgO} {C}_{p , MgO} + {m}_{mod} {C}_{p , mod} )}$$

where ΔH is the enthalpy per mole of reaction, M_{Mg} is the molar mass of Mg, m_{Mg}, m_{Si}, m_{MgO}, m_{mod} are the mass of Mg, Si, MgO, and moderator respectively, and C_{p, Si}, C_{p,MgO}, C_{p,mod} are the specific heat capacity of Si, MgO, and moderator respectively.

In some embodiments, the ΔT may be maintained in a range of from about 300° C. to about 900° C. or from about 300° C. to about 700° C. The ΔT may be controlled by, for example, varying an amount of moderator used in the reaction. In general, increased amounts of moderator will reduce the ΔT as the moderator constitutes thermal mass that will absorb reaction heat. Moderators may include, but are not limited to, sodium chloride, alumina, alumina silicate, zirconia, zirconia silicate, magnesia, carbon, silicon carbide, silicon nitride, or any material that has a melting point of at least 800° C. The exposure time of the PSFT to the ΔT may be very quick (e.g., nearly spontaneous). In some embodiments, a thermally insulating crucible, such as an alumina crucible, may prolong the effects of the ΔT such that larger crystallites may be formed at relatively lower ΔT (e.g., from about 200° C. to about 600° C.).

High ΔT or long exposures thereto may result in a number of byproducts, such as forsterite, ringwoodite, crystalline silica, spinel, enstatite, and/or pyroxene. In some embodiments, the PSFT may undergo a wash, such as an acid wash, to remove one or more of these byproducts. In some embodiments, the PSFT—before or after a wash—may include at most 10 wt %, at most 5 wt %, at most 3 wt %, at most 2 wt %, or at most 1 wt % of total byproducts. In some embodiments, forsterite is present in the washed or unwashed PSFT in an amount of at most 5 wt %, at most 3 wt %, at most 2 wt %, less than 2 wt %, or less than 1 wt %. In some embodiments, ringwoodite is present in the washed or unwashed PSFT in an amount of at most 3 wt %, at most 2 wt %, less than 2 wt %, or less than 1 wt %. In some embodiments, enstatite is present in the washed or unwashed PSFT in an amount of at most 3 wt %, at most 2 wt %, less than 2 wt %, less than 1 wt %, or less than 0.5 wt %. In some embodiments, spinel is present in the washed or unwashed PSFT in an amount of at most 3 wt %, at most 2 wt %, less than 2 wt %, less than 1 wt %, or less than 0.5 wt %. In some embodiments, crystalline silica is present in the washed or unwashed PSFT in an amount of at most 3 wt %, at most 2 wt %, less than 2 wt %, less than 1 wt %, or less than 0.5 wt %. In some embodiments, pyroxene is present in the washed or unwashed PSFT in an amount of at most 3 wt %, at most 2 wt %, less than 2 wt %, less than 1 wt %, or less than 0.5 wt %. In some embodiments, the ΔT is maintained below 700° C., below 600° C., or below 500° C. in order to minimize the formation of such byproducts.

In some embodiments, a maximum reaction temperature observed (typically, for a fraction of a second) during the magnesiothermic reduction of silica fibers is 1500° C., 1400° C., 1300° C., 1200° C., 1100° C., 1000° C., 900° C., 800° C., 700° C., or 600° C. In some embodiments, the maximum reaction temperature is at least 300° C., 400° C., 500° C., 600° C., 700° C., 800° C., 900° C., 1000° C., 1100° C., 1200° C., 1300° C., or 1400° C. In some embodiments, the maximum reaction temperature may range between any logical combination of the foregoing upper and lower bounds.

The PSFT comprising metallic silicon functions as a template matrix for incorporating carbon to form the composite fiber. The metallic silicon-containing fiber may also have a mean pore diameter in the range of 5 to 80 nm, a pore volume in the range of 0.2 to 0.9 cm³/g, and a specific surface area in the range of 50 to 350 m²/g. The PSFT may have a crystalline silicon content (Si %) of 50-100 wt %, at least 75 wt %, 75 to 90 wt %, or at least 90 wt % and a silicon crystallite size of 10 to 100 nm, 15 to 50 nm, 20 to 50 nm, 20 to 45 nm, or 20 to 40 nm.

In some embodiments, the PSFT comprises crystalline silicon, in the range of 50 to 100 wt %, and amorphous silicon oxide (SiOₓ), in the range of 0 to 50 wt %, determined by Rietveld analysis. The amorphous silicon oxide in the PSFT is either stoichiometric (SiO₂) or nonstoichiometric, SiOₓ where x<2. In some embodiments, the PSFT, prior to being infiltrated with carbon, comprises at least 50 wt %, at least 60 wt %, at least 70 wt %, at least 75 wt %, 75 to 90 wt %, at least 80 wt %, or at least 90 wt % of crystalline silicon (nano-crystalline silicon). The PSFT may comprise at most 50 wt %, at most 40 wt %, at most 30 wt %, at most 20 wt %, or at most 10 wt % of amorphous or crystalline silicon oxide. The PSFT may comprise at most 15 wt %, at most 10 wt %, or at most 5 wt % of impurities (components other than silicon or silicon oxide).

An example of material properties for the PSFT is summarized in Table 1 below. The material properties can be controlled through the reduction recipe design, firing temperature program, post heat treatment, load ratio, and/or the particle size of the moderator. For example, varying the particle size of the moderator will vary the stacking density of the batch or the space partition among the reactants. With larger moderator particles, the crystallite size tends to be larger. In some embodiments, larger crystallite sizes may be achieved by a two-step firing process wherein a first firing is conducted in the presence of a moderator to achieve crystallite sizes of about 6 to 12 nm and a second firing in the presence of a reduced amount of moderator (or no moderator) increases the crystallite sizes to about 20 to 100 nm. Between the first and second firings, the fired batch is screened to remove the moderator from the first firing and/or washed to remove magnesium oxide (MgO). With respect to the load ratio, a higher load relative to the size of the heating vessel (e.g., a crucible, conveyor belt, or rotary kiln) typically results in larger crystallite sizes as the heating vessel acts as a moderator. That is, in a continuous process, a higher feed rate onto a conveyor belt can result in larger crystallite sizes and, in a batch process, a higher loading amount within the batch can result in larger crystallite sizes. In some embodiments, a weight ratio of the moderator (e.g., sodium chloride and/or alumina) to the magnesium is at most 15, at most 12, at most 10, or at most 7.

TABLE 1
Material properties of Si fiber template

| Si fiber template | |
|---|---|
| properties | Range |
| Si wt % | 75-90 or at least 90 |
| Si size (nm) | 10-100 or 15-50 |
| SSA (m²/g) | 50-350 or 80-200 |
| Pore size (nm) | 5-80 |
| Pore volume (cm³/g) | 0.2-0.9 |

In one or more embodiments, to form the composite fiber, the PSFT is infiltrated with carbon. In such embodiments, the Si—C composite fiber may have a carbon content of 20 to 70 wt %, 20 to 45 wt %, 32 to 50 wt %, or 30 to 50 wt %, with an FCE of at least 78% and a 1st cycle specific delithiation capacity (1SDC) of at least 1300 mAh/g or at least 1800 mAh/g in a half-cell test.

In one or more embodiments, the majority of the elements in the composite fiber are Si, C, and oxygen (O), with these elements accounting for, for example, at least 50 wt %, at least 60 wt %, at least 70 wt %, at least 80 wt %, at least 90 wt %, at least 95 wt %, at least 99 wt %, or at least 99.5 wt % of the composite fiber.

In some embodiments, the composite fiber has a value for Formula 1 below of at least 77, at least 78, at least 79, or at least 80, wherein X is an average silicon crystallite size in the Si phase in nm and Y is the percent by weight of the C phase based on a total weight of the composite fiber:

85.634*X/(X+0.0824*(62.79−Y)) Formula 1

In some embodiments, the composite fiber has a value for Formula 2 below of at least 1200, at least 1300, at least 1400, at least 1500, at least 1800, or at least 2000, wherein Y is the percent by weight of the C phase based on a total weight of the composite fiber and Z is the percent by weight of elemental silicon in the Si phase:

31.486*(100−Y)*Z/100 Formula 2

In some embodiments, the composite fiber includes an Si phase having at least 90 wt % of crystalline silicon having an average crystallite size of 20 to 40 nm and a C phase comprising 20 to 45 wt % of the composite fiber. An anode including this composite fiber may be able to provide a 1SDC of greater than 1800 mAh/g and an FCE of greater than 78%.

In some embodiments, the composite fiber includes an Si phase having 75-90 wt % of crystalline silicon having an average crystallize size of 20 to 45 nm and a C phase comprising 32 to 50 wt % of the composite fiber. An anode including this composite fiber may be able to provide a 1SDC of greater than 1300 mAh/g, an FCE of greater than 78%, and a tenth cycle Coulombic efficiency (10CE) of greater than 98.7%.

According to embodiments of the present disclosure, the FCE is improved by forming the composite fiber of intertwined Si—C domains. It can be expected that the specific capacity reduces to the minimum at 100% carbon (about 372 mAh/g if the carbon is pure graphite and even less if the carbon is carbon black). Therefore, it is important to balance the FCE and capacity by appropriately adjusting the infiltration amount of carbon, especially in the full cell or battery design.

The amount of carbon that can be infiltrated into the PSFT is generally limited by a pore volume of the PSFT, i.e., the void space accessible to the carbon. Higher pore volume allows more carbon to infiltrate, thus resulting in a higher possible carbon content.

As carbon or silicon is infiltrated into the PSFT or carbon fiber, the total volume of the formed Si—C composite is not changed relative to the original PSFT or carbon fiber template. However, the FCE is significantly improved and the charging and discharging volumetric capacity of a single fiber is increased. As such, the composite Si—C fibers are able to provide superior properties as compared with simple mixtures of Si fiber and carbon materials (e.g., carbon black or graphite).

Without being bound by theory, this is believed to be at least in part due to the electron and lithium ion transport and diffusion rate being improved because of the interconnected carbon network in the fiber. Electrons and lithium ions have a higher diffusion rate in carbon than silicon. The interconnected carbon network in the composite fiber facilitates the transport of electrons and lithium ions from an outer surface of the composite fiber to the interior of the composite fiber or the transport from the interior of the composite fiber to the outer surface of the composite fiber. Therefore, the number of electrons and lithium ions as well as their transport rate increases with the carbon content in the fiber.

The diffusion rate improvement also reduces the exposure time of tension stress buildup on the surface of the Si domain in the delithiation step, which helps avoid the cracking of silicon domains. The diffusion rate improvement also helps reduce the exposure time of tension stress buildup of the fiber surface in the delithiation step, and thus avoids the cracking of the fiber surface.

In some embodiments, the composite fiber may comprise lithium wherein the lithium and at least a portion of the silicon from the Si phase form an LiₓSi alloy where x is from greater than 0 to 4. In some embodiments, the lithium-containing composite fiber further comprises Li₂SiO₃. In some embodiments, the lithium-containing composite fiber may be formed by making a nanoporous fibrous structure of one of silicon or carbon, subsequently infiltrating the structure with the other of carbon or silicon, and then reacting the infiltrated structure with a lithium source to form the LiₓSi alloy. In other embodiments, the lithium-containing composite fiber may be formed by making a nanoporous fibrous structure of silicon, then reacting the structure with a lithium source to form the LiₓSi alloy, and finally infiltrating the structure with carbon. In yet other embodiments, the lithium-containing composite can be formed by introducing lithium into a Si—C composite fiber to form the LiₓSi alloy.

### EXAMPLES

### Example 1

Batches of PSFT were formed using magnesiothermic reduction under varying conditions and each was subsequently infiltrated with carbon. The resulting fibers had compositions as shown in Tables 2 and 3 below. Half-cells were prepared for several of the batches of fibers and the FCE, 5 cycle Coulombic efficiency (5CE), 1SDC, and tenth cycle Coulombic efficiency (10CE) were determined. The results are summarized in Table 4 below.

TABLE 2

| | PSFT Properties | | | | | | |
|---|---|---|---|---|---|---|---|
| | | Pore | Pore | Si | | | |
| Composite | SSA | Volume | Size | Crystallites | Si | Forsterite | Ringwoodite |
| Fiber | (m²/g) | (cm³/g) | (nm) | (nm) | (wt %) | (wt %) | (wt %) |
| Comp. Ex. 1 | | | | 181.30 | 88.46 | | |
| Comp. Ex. 2 | 2.6 | 0.02 | 30.5 | 112.00 | 77.30 | | |
| Comp. Ex. 3 | 1.1 | 0.00 | 31.5 | 45.50 | 56.90 | 1.5 | |
| Comp. Ex. 4 | 2.5 | 0.02 | 35.0 | 38.50 | 87.62 | 3.3 | 1.5 |
| Comp. Ex. 5 | 4.0 | 0.03 | 29.4 | 24.20 | 92.90 | | |
| Example 1 | | | | 24.60 | 91.60 | 1.7 | 0.6 |
| Example 2 | | | | 29.10 | 94.60 | 0.4 | 1.7 |
| Example 3 | | | | 24.60 | 91.60 | 1.7 | 0.6 |
| Example 4 | 59.8 | 0.28 | 28.5 | 29.90 | 93.00 | 0.9 | 0.7 |
| Example 5 | | | | 28.70 | 91.50 | 0.9 | 0.7 |
| Example 6 | 46.2 | 0.25 | | 25.10 | 96.90 | | |
| Example 7 | | | | 28.70 | 96.40 | | |
| Example 8 | | | | 32.90 | 90.50 | | |
| Example 9 | | | | 30.80 | 93.45 | | |
| Example 10 | | | | 27.30 | 93.11 | | |
| Example 11 | 41.8 | 0.24 | 29.4 | 29.60 | 93.00 | | |
| Example 12 | | | | 29.50 | 94.00 | | |
| Example 13 | | | | 29.4 | 92.7 | | |
| Example 14 | | | | 29.4 | 92.7 | | |
| Example 15 | | | | 29.4 | 92.7 | 0.7 | 1.5 |
| Comp. Ex. 6 | | | | 28.70 | 91.50 | 0.4 | 1.8 |
| Comp. Ex. 7 | | | | 28.70 | 91.50 | 0.4 | 1.8 |
| Example 16 | 56.7 | 0.17 | 15.0 | 36.30 | 87.54 | | |
| Example 17 | | | | 26.30 | 87.31 | 0.62% | |
| Example 18 | | | | 26.30 | 87.31 | 0.62% | |
| Example 19 | 30.9 | 0.12 | 19.9 | 35.80 | 86.92 | | |
| Example 20 | | | | 28.40 | 80.63 | 0.82% | |
| Example 21 | | | | 28.40 | 80.63 | 0.82% | |
| Example 22 | 15.9 | | 23.7 | 28.30 | 77.80 | | |
| Example 23 | | | | 22.40 | 76.96 | 2.23% | |
| Example 24 | | | | 22.40 | 76.96 | 2.23% | |
| Example 25 | | | | 22.9 | 97.8 | | |
| Example 26 | | | | 20.8 | 96.3 | | |
| Example 27 | 64.3 | 0.26 | 19.9 | 20.1 | 94.6 | | |
| Comp. Ex. 8 | 11.7 | 0.07 | 28.4 | 17.1 | 97 | | |
| Comp. Ex. 9 | 3.4 | 0.02 | 22.9 | 10.3 | 91.4 | | |
| Comp. Ex. 10 | 16.0 | 0.05 | 17.3 | 10.6 | 84 | | |
| Comp. Ex. 11 | 72.0 | 0.19 | 12.0 | 10.6 | 84 | | |
| Comp. Ex. 12 | 69.0 | 0.28 | 20.6 | 14.60 | 92.00 | | |
| Comp. Ex. 13 | 66.0 | 0.24 | 17.3 | 14.70 | 78.60 | | |
| Comp. Ex. 14 | 66.0 | 0.24 | 17.3 | 14.70 | 78.60 | | |
| Comp. Ex. 15 | 67.0 | 0.17 | 12.0 | 11.50 | 77.60 | | |
| Comp. Ex. 16 | 55.0 | 0.16 | 13.9 | 11.50 | 77.57 | | |
| Comp. Ex. 17 | 45.0 | 0.18 | 18.6 | 15.30 | 76.80 | | |
| Comp. Ex. 18 | 2.8 | 0.02 | 27.4 | 11.60 | 76.43 | | |
| Comp. Ex. 19 | 6.0 | 0.02 | 13.5 | 8.60 | 76.30 | | |
| Comp. Ex. 20 | 1.9 | 0.00 | 31.5 | 6.00 | 69.00 | | |
| Comp. Ex. 21 | 1.8 | 0.01 | 15.6 | 7.80 | 85.65 | | |
| Comp. Ex. 22 | 33.0 | 0.07 | 11.0 | 8.70 | 64.60 | | |
| Comp. Ex. 23 | 73.9 | 0.18 | 15.5 | 8.80 | 78.19 | | |
| Comp. Ex. 24 | 86.1 | 0.21 | | 8.00 | 73.10 | | |
| Comp. Ex. 25 | 63.4 | 0.16 | 13.5 | 8.00 | 68.70 | | |
| Comp. Ex. 26 | 16.3 | 0.05 | 14.5 | 8.20 | 67.60 | | |
| Comp. Ex. 27 | 1.1 | 0.01 | 28.4 | 7.80 | 64.39 | | |
| Comp. Ex. 28 | 30.5 | | 11.7 | 7.70 | 62.88 | | |
| Comp. Ex. 29 | 10.4 | 0.04 | 15.5 | 7.70 | 62.88 | | |
| Comp. Ex. 30 | 32.0 | 0.08 | 11.5 | 7.40 | 59.60 | | |
| Comp. Ex. 31 | 16.5 | 0.05 | 14.0 | 8.00 | 59.20 | | |
| Comp. Ex. 32 | 68.0 | 0.14 | 12.0 | 8.00 | 53.00 | | |

TABLE 3

| | Composite Fiber Properties | | | | |
|---|---|---|---|---|---|
| Composite | | SSA | Pore Volume | Pore Size | Tap Density |
| Fiber | C (wt %) | (m²/g) | (cm³/g) | (nm) | (g/cm³) |
| Comp. Ex. 1 | 39.20 | | | | 0.54 |
| Comp. Ex. 2 | 32.90 | 2.6 | 0.02 | 30.5 | 0.59 |
| Comp. Ex. 3 | 31.20 | 1.1 | 0.00 | 31.5 | 0.55 |
| Comp. Ex. 4 | 62.20 | 2.5 | 0.02 | 35.0 | |
| Comp. Ex. 5 | 61.60 | 4.0 | 0.03 | 29.4 | 0.57 |
| Example 1 | 40.90 | | | | |
| Example 2 | 37.80 | | | | |
| Example 3 | 37.00 | | | | |
| Example 4 | 34.90 | 59.8 | 0.28 | 28.5 | 0.50 |
| Example 5 | 35.00 | | | | |
| Example 6 | 34.70 | 46.2 | 0.25 | | 0.49 |
| Example 7 | 33.70 | | | | |
| Example 8 | 32.80 | | | | |
| Example 9 | | | | | |
| Example 10 | 31.40 | | | | |
| Example 11 | 30.80 | 41.8 | 0.24 | 29.4 | 0.59 |
| Example 12 | 29.70 | | | | |
| Example 13 | 30.60 | | | | |
| Example 14 | | | | | |
| Example 15 | 23.90 | | | | |
| Comp. Ex. 6 | 17.90 | | | | |
| Comp. Ex. 7 | 12.90 | | | | |
| Example 16 | 32.10 | 56.7 | 0.17 | 15.0 | 0.56 |
| Example 17 | 41.22 | | | | |
| Example 18 | 46.23 | | | | |
| Example 19 | 37.10 | 30.9 | 0.12 | 19.9 | 0.57 |
| Example 20 | 46.37 | | | | |
| Example 21 | 39.98 | | | | |
| Example 22 | 45.80 | 15.9 | | 23.7 | |
| Example 23 | 48.67 | | | | |
| Example 24 | 43.31 | | | | |
| Example 25 | 48.10 | | | | |
| Example 26 | 39.80 | | | | |
| Example 27 | 42.40 | 64.3 | 0.26 | 19.9 | |
| Comp. Ex. 8 | 60.20 | 11.7 | 0.07 | 28.4 | 0.51 |
| Comp. Ex. 9 | 59.10 | 3.4 | 0.02 | 22.9 | 0.47 |
| Comp. Ex. 10 | 51.80 | 16.0 | 0.05 | 17.3 | |
| Comp. Ex. 11 | 40.60 | 72.0 | 0.19 | 12.0 | 0.69 |
| Comp. Ex. 12 | 40.20 | 69.0 | 0.28 | 20.6 | |
| Comp. Ex. 13 | 45.60 | | | | |
| Comp. Ex. 14 | 33.00 | 66.0 | 0.24 | 17.3 | |
| Comp. Ex. 15 | 41.20 | 67.0 | 0.17 | 12.0 | 0.69 |
| Comp. Ex. 16 | 44.60 | 55.0 | 0.16 | 13.9 | |
| Comp. Ex. 17 | 39.30 | 45.0 | 0.18 | 18.6 | |
| Comp. Ex. 18 | 58.90 | 2.8 | 0.02 | 27.4 | 0.44 |
| Comp. Ex. 19 | 65.50 | 6.0 | 0.02 | 13.5 | 0.36 |
| Comp. Ex. 20 | 61.30 | 1.9 | 0.00 | 31.5 | 0.32 |
| Comp. Ex. 21 | 29.70 | 1.8 | 0.01 | 15.6 | 0.52 |
| Comp. Ex. 22 | 39.80 | 33.0 | 0.07 | 11.0 | 0.72 |
| Comp. Ex. 23 | 38.30 | 73.9 | 0.18 | 15.5 | 0.63 |
| Comp. Ex. 24 | 34.80 | 86.1 | 0.21 | | |
| Comp. Ex. 25 | 34.60 | 63.4 | 0.16 | 13.5 | |
| Comp. Ex. 26 | 46.90 | 16.3 | 0.05 | 14.5 | 0.46 |
| Comp. Ex. 27 | 47.60 | 1.1 | 0.01 | 28.4 | 0.47 |
| Comp. Ex. 28 | 37.00 | 30.5 | | 11.7 | 0.73 |
| Comp. Ex. 29 | 39.80 | 10.4 | 0.04 | 15.5 | 0.75 |
| Comp. Ex. 30 | 35.60 | 32.0 | 0.08 | 11.5 | 0.70 |
| Comp. Ex. 31 | 43.60 | 16.5 | 0.05 | 14.0 | |
| Comp. Ex. 32 | 35.94 | 68.0 | 0.14 | 12.0 | |

TABLE 4

| Composite | Half-Cell Properties | | | |
|---|---|---|---|---|
| Fiber | FCE (%) | 5CE (%) | 10CE (%) | 1SDC (mAh/g) |
| Comp. Ex. 1 | 75.8 | 89.9 | 93.3 | 1162 |
| Comp. Ex. 2 | 62.1 | 89.9 | 95 | 1057 |
| Comp. Ex. 3 | 85.2 | 88.8 | 97.4 | 1199 |
| Comp. Ex. 4 | 81.2 | 98.3 | 98.5 | 1240 |
| Comp. Ex. 5 | 81.9 | 98.7 | 99 | 879 |
| Example 1 | 79.7 | 98.2 | 98.5 | 1995 |
| Example 2 | 83.1 | 98.5 | 98.7 | 1834 |
| Example 3 | 80 | 97.9 | 98.2 | 2078 |
| Example 4 | 81.9 | 98.3 | 98.5 | 2087 |
| Example 5 | 81.9 | 98.3 | 98.5 | 2087 |
| Example 6 | 81.6 | 98.3 | 98.2 | 2188 |
| Example 7 | 79.6 | 96.7 | 96.3 | 2242 |
| Example 8 | 79.7 | 96.5 | 98 | 2167 |
| Example 9 | 78.2 | 97.1 | 97.6 | 2356 |
| Example 10 | 79.3 | 97.4 | 96.5 | 2000 |
| Example 11 | 80.3 | 97.2 | 96.5 | 2027 |
| Example 12 | 79.82 | 97.9 | 97.9 | 2123 |
| Example 13 | 80.9 | 98.1 | 98.4 | 2154 |
| Example 14 | 83.2 | 98 | 97.8 | 2153 |
| Example 15 | 81.7 | 97.8 | 97.4 | 2339 |
| Comp. Ex. 6 | 73.6 | 95.2 | 95.7 | 2464 |
| Comp. Ex. 7 | 66.6 | 93.9 | 96.4 | 2482 |
| Example 16 | 80.4 | 98.6 | 98.9 | 1946 |
| Example 17 | 82.46 | 98.42 | 98.71 | 1730 |
| Example 18 | 82.82 | 98.53 | 98.84 | 1622 |
| Example 19 | 81.5 | 98.8 | 99.1 | 1846 |
| Example 20 | 81.45 | 99.07 | 99.36 | 1347 |
| Example 21 | 80.32 | 98.73 | 99 | 1664 |
| Example 22 | 79 | 98.8 | 99.2 | 1331 |
| Example 23 | 81.57 | 98.82 | 99.08 | 1308 |
| Example 24 | 78.8 | 98.83 | 99.13 | 1514 |
| Example 25 | 83.8 | 98.6 | 98.8 | 1679 |
| Example 26 | 81.5 | 98.5 | 98.8 | 1897 |
| Example 27 | 78.7 | 98.3 | 98.6 | 1919 |
| Comp. Ex. 8 | 79.2 | 97.5 | 95.5 | 860 |
| Comp. Ex. 9 | 80.3 | 99.1 | 99.4 | 1193 |
| Comp. Ex. 10 | 77.96 | 99.19 | 99.49 | 1262 |
| Comp. Ex. 11 | 74.37 | 99 | 99 | 1493 |
| Comp. Ex. 12 | 73.53 | 98.43 | 98.8 | 2105 |
| Comp. Ex. 13 | 74.27 | 98.95 | 99.24 | 1549 |
| Comp. Ex. 14 | 73.7 | 98.71 | 99.1 | 1572 |
| Comp. Ex. 15 | 73.25 | 98.74 | 99.1 | 1565 |
| Comp. Ex. 16 | 73.66 | 99.02 | 99.41 | 1498 |
| Comp. Ex. 17 | 74.46 | 98.8 | 99.1 | 1371 |
| Comp. Ex. 18 | 75.4 | 99.1 | 99.5 | 1111 |
| Comp. Ex. 19 | 74 | 98.8 | 99.3 | 931 |
| Comp. Ex. 20 | 69.9 | 98.9 | 99.1 | 788 |
| Comp. Ex. 21 | 66.4 | 98.2 | 98.8 | 1565 |
| Comp. Ex. 22 | 72.99 | 99.01 | 99.35 | 1226 |
| Comp. Ex. 23 | 71.5 | 98.9 | 99.3 | 1382 |
| Comp. Ex. 24 | 70.85 | 98.58 | 99.1 | 1328 |
| Comp. Ex. 25 | 68.85 | 98.92 | 99.34 | 1176 |
| Comp. Ex. 26 | 72.4 | 98.3 | 98.9 | 1113 |
| Comp. Ex. 27 | 68.6 | 98 | 98.5 | 590 |
| Comp. Ex. 28 | 69.01 | 98.8 | 99.2 | 1005 |
| Comp. Ex. 29 | 68.03 | 98.7 | 99.2 | 1039 |
| Comp. Ex. 30 | 70.89 | 98.83 | 99.23 | 1067 |
| Comp. Ex. 31 | 71.98 | 98.8 | 99.3 | 1068 |
| Comp. Ex. 32 | 68.08 | 98.27 | 98.87 | 1221 |

Blank cells in Tables 2-4 indicate properties that were not measured and/or could not be detected.

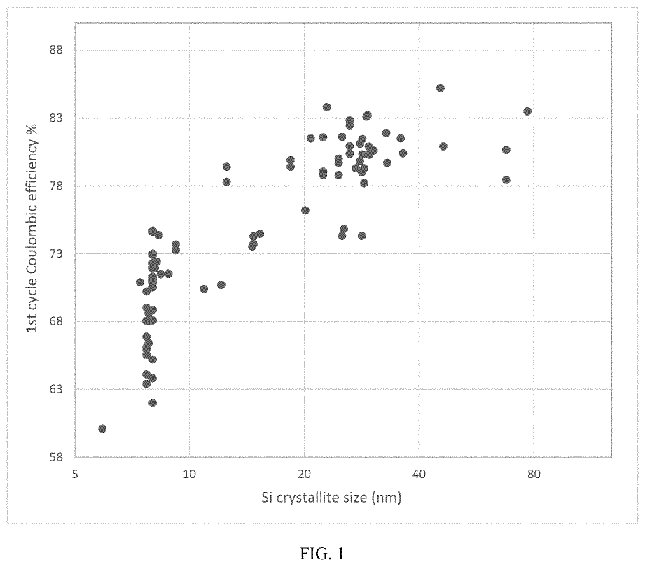

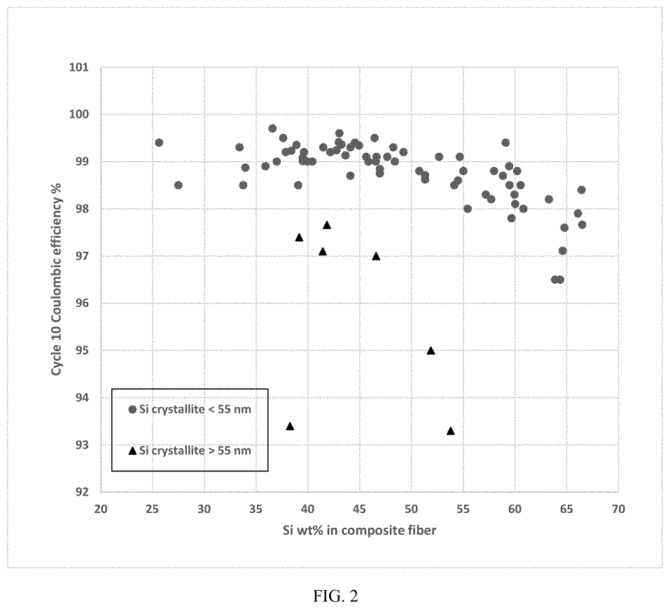

As shown above, by maintaining the desired silicon content, crystallite size, and carbon content, Examples 1-27 each achieved an FCE of at least 78% and a 1SDC of at least 1300 mAh/g. Conversely, Comparative Examples 1 and 2 had very large crystallites and provided an FCE of 75.8% and 62.1%, respectively, and a 1SDC of 1162 and 1057 mAh/g, respectively. Comparative Example 3 had a low silicon content and poor 1SDC. Comparative Examples 4 and 5 had very high carbon content and insufficient 1SDC. Comparative Examples 6 and 7 had good 1SDC but the low carbon content resulted in poor FCE. Comparative Examples 8-18 had small crystallites and/or high carbon content and the resultant 1SDC and/or FCE were insufficient. Comparative Examples 19-32 each had silicon crystallite sizes of below 10 nm and only achieved an FCE of up to 65.5%. FIG. 1 shows the effects of silicon crystallite size on the 1SDC. FIG. 2 shows the effects of silicon content in the composite fiber and the silicon crystallite size on the 10CE.

### Example 2: Heat Effect on Crystallite Size

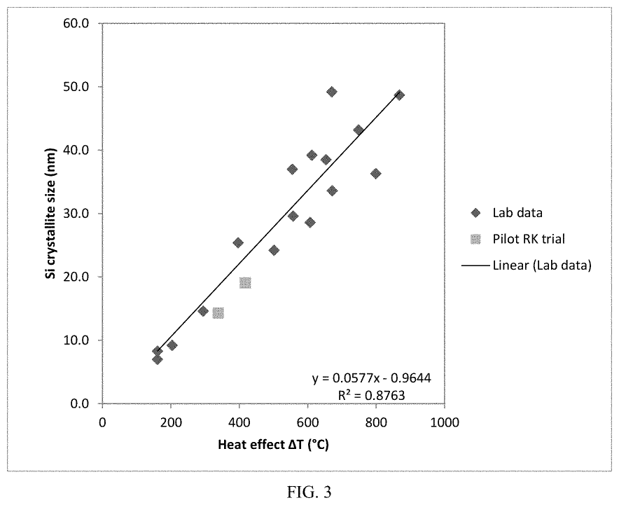

Table 5 below summarizes the reduction conditions for select PSFT from Table 2 above. To form the PSFT, a mixture of silica fiber, Mg, and moderator (sodium chloride, alumina beads, and/or tabular alumina) was loaded into a reactor. In particular, Comparative Examples 1-3 used an alumina crucible, Comparative Examples 4, 5, 10-20, and 26-30 and Examples 6, 7, 9, 11, 22, and 26 used a metal crucible, and the remaining examples used a rotary kiln. The reactions were performed in an argon atmosphere and the fibers were washed before being analyzed (analysis results in Table 2). As shown, by controlling the reaction conditions, such as the ratio of moderator to magnesium, the crystallite size can be tailored to fall within the ranges disclosed herein. Select examples are plotted in FIG. 3 to demonstrate the effect of ΔT on silicon crystallite size.

TABLE 5

| | | | Moderator | | |
|---|---|---|---|---|---|
| | | | (NaCl/alumina | | |
| | | | beads/tabular | | |
| PSFT | Si Fiber (g) | Mg (g) | alumina) (g) | Heating Schedule | ΔT (° C.) |
| Comp. | 40.0 | 12 | 0/0/0 | 10° C./min -> 650° C., 0 hrs | |
| Ex. 1 | | | | hold -> Cool; | |
| Comp. | 40.0 | 8 | 0/0/0 | 10° C./min -> 650° C., 0 hrs | |
| Ex. 2 | | | | hold -> Cool; | |
| Comp. | 40.0 | 5 | 0/0/0 | 10° C./min -> 650° C., 0 hrs | |
| Ex. 3 | | | | hold -> Cool; | |
| Comp. | 80.5 | 57 | 400.0/0/0 | 10° C./min -> 650° C., 0 hrs -> | 653.4796 |
| Ex. 4 | | | | Cool; | |
| Comp. | 161.0 | 125 | 1217.0/0/0 | 10° C./min -> 400° C. -> | 501.555 |
| Ex. 5 | | | | 1° C./min -> 650° C., 7 hrs -> | |
| | | | | Cool; | |
| Example | 1200.0 | 900 | 6002.0/0/0 | 10° C./min -> 400° C. -> | 684.6974 |
| 1 | | | | 5° C./min -> 650° C., 1 hrs -> | |
| | | | | Cool; | |
| Example | 1200.0 | 900 | 6002.0/0/0 | 10° C./min -> 400° C. -> | 684.6974 |
| 2 | | | | 5° C./min -> 650° C., 3 hrs -> | |
| | | | | Cool; | |
| Example | 1200.0 | 900 | 6002.0/0/0 | 10° C./min -> 400° C. -> | 684.6974 |
| 3 | | | | 5° C./min -> 650° C., 1 hrs -> | |
| | | | | Cool; | |
| Example | 1200.0 | 900 | 6002.0/0/0 | 10° C./min -> 400° C. -> | 684.6974 |
| 4 | | | | 5° C./min -> 650° C., 3 hrs -> | |
| | | | | Cool; | |
| Example | 1200.0 | 900 | 6002.0/0/0 | 10° C./min -> 400° C. -> | 684.6974 |
| 5 | | | | 5° C./min -> 650° C., 3 hrs -> | |
| | | | | Cool; | |
| Example | 1270.0 | 950 | 6300.0/0/0 | 10° C./min -> 400° C. -> | 687.6002 |
| 6 | | | | 5° C./min -> 650° C., 5 hrs -> | |
| | | | | Cool; | |
| Example | 1260.0 | 1000 | 6300.0/0/0 | 10° C./min -> 400° C. -> | 720.5708 |
| 7 | | | | 5° C./min -> 650° C., 5 hrs -> | |
| | | | | Cool; | |
| Example | 1260.0 | 1000 | 6300.0/0/0 | 10° C./min -> 400° C. -> | 720.5708 |
| 9 | | | | 5° C./min -> 650° C., 5 hrs -> | |
| | | | | Cool; | |
| Example | 80.5 | 58.5 | 500.0/0/0 | 10° C./min -> 650° C., 0 hrs -> | 557.1873 |
| 11 | | | | Cool; | |
| Example | 900.0 | 675 | 900.0/6000/0 | 10° C./min -> 400° C. -> | |
| 12 | | | | 5° C./min -> 650° C., 1 hr -> | |
| | | | | Cool | |
| Example | 900.0 | 675 | 900.0/6000/0 | 10° C./min -> 400° C. -> | |
| 13 | | | | 5° C./min -> 650° C., 4 hr -> | |
| | | | | Cool | |
| Example | 900.0 | 675 | 1000.0/6500/0 | 10° C./min -> 400° C. -> | |
| 14 | | | | 5° C./min -> 650° C., 1 hr -> | |
| | | | | Cool | |
| Example | 1200.0 | 900 | 6002.0/0/0 | 10° C./min -> 400° C. -> | 684.6974 |
| 15 | | | | 5° C./min -> 650° C., 3 hrs -> | |
| | | | | Cool; | |
| Comp. | 1200.0 | 900 | 12600.0/12600/0 | 10° C./min -> 400° C. -> | 364.034 |
| Ex. 6 | | | | 5° C./min -> 650° C., 1 hrs -> | |
| | | | | Cool; | |
| Comp. | 1200.0 | 900 | 12600.0/12600/0 | 10° C./min -> 400° C. -> | 364.034 |
| Ex. 7 | | | | 5° C./min -> 650° C., 1 hrs -> | |
| | | | | Cool; | |
| Example | 900.0 | 675 | 9454.0/9454/0 | 10° C./min -> 400° C. -> | 363.8962 |
| 16 | | | | 5° C./min -> 650° C., 3 hrs -> | |
| | | | | Cool; | |
| Example | 900.0 | 585 | 0.0/0/7000 | 10° C./min -> 400° C. -> | |
| 17 | | | | 5° C./min -> 650° C., 1 hr -> | |
| | | | | Cool | |
| Example | 900.0 | 585 | 0.0/0/7000 | 10° C./min -> 400° C. -> | |
| 18 | | | | 5° C./min -> 650° C., 1 hr -> | |
| | | | | Cool | |
| Example | 900.0 | 570 | 0.0/0/7000 | 10° C./min -> 400° C. -> | |
| 20 | | | | 5° C./min -> 650° C., 1 hr -> | |
| | | | | Cool | |
| Example | 900.0 | 570 | 0.0/0/7000 | 10° C./min -> 400° C. -> | |
| 21 | | | | 5° C./min -> 650° C., 1 hr -> | |
| | | | | Cool | |
| Example | 170.0 | 110 | 600.0/600/0 | 10° C./min -> 650° C., 4 hrs -> | 587.8178 |
| 22 | | | | Cool; | |
| Example | 900.0 | 513 | 0.0/0/7000 | 10° C./min -> 400° C. -> | |
| 23 | | | | 5° C./min -> 650° C., 1 hr -> | |
| | | | | Cool | |
| Example | 900.0 | 513 | 0.0/0/7000 | 10° C./min -> 400° C. -> | |
| 24 | | | | 5° C./min -> 650° C., 1 hr -> | |
| | | | | Cool | |
| Example | 1320.0 | 990 | 7694.0/0/0 | 10° C./min -> 400° C. -> | 604.5845 |
| 25 | | | | 5° C./min -> 650° C., 3 hrs -> | |
| | | | | Cool; | |
| Example | 161.0 | 117 | 1150.0/0/0 | 10° C./min -> 400° C. -> | 495.1209 |
| 26 | | | | 3° C./min -> 650° C., 3 hrs -> | |
| | | | | Cool; | |
| Example | 900.0 | 675 | 0.0/10080/0 | 10° C./min -> 400° C. -> | |
| 27 | | | | 5° C./min -> 650° C., 4 hr -> | |
| | | | | Cool | |
| Comp. | 600.0 | 450 | 5399.0/0/0 | 10° C./min -> 650° C., 1 hr -> | 417.4255 |
| Ex. 8 | | | | Cool; | |
| Comp. | 57.0 | 41.5 | 1401.5/0/0 | | 160.7488 |
| Ex. 10 | | | | | |
| Comp. | 57.0 | 41.5 | 1401.5/0/0 | | 160.7488 |
| Ex. 11 | | | | | |
| Comp. | 97.0 | 75 | 1331.0/0/0 | 10° C./min -> 400° C. -> | 294.1066 |
| Ex. 12 | | | | 1° C./min -> 650° C., 7 hrs -> | |
| | | | | Cool; | |
| Comp. | 109.0 | 75 | 1319.0/0/0 | 10° C./min -> 400° C. -> | 295.0328 |
| Ex. 13 | | | | 1° C./min -> 650° C., 7 hrs -> | |
| | | | | Cool; | |
| Comp. | 109.0 | 75 | 1319.0/0/0 | 10° C./min -> 400° C. -> | 295.0328 |
| Ex. 14 | | | | 1° C./min -> 650° C., 7 hrs -> | |
| | | | | Cool; | |
| Comp. | 61.5 | 44.8 | 1178.7/0/0 | | 203.6018 |
| Ex. 15 | | | | | |
| Comp. | 61.5 | 44.8 | 1178.7/0/0 | | 203.6018 |
| Ex. 16 | | | | | |
| Comp. | 169.5 | 100 | 1233.5/0/0 | 10° C./min -> 400° C. -> | 400.9343 |
| Ex. 17 | | | | 1° C./min -> 650° C., 7 hrs -> | |
| | | | | Cool; | |
| Comp. | 45.0 | 40 | 1384.3/0/0 | 10° C./min -> 400° C. -> | 157.7123 |
| Ex. 18 | | | | 1° C./min -> 650° C., 7 hrs -> | |
| | | | | Cool; | |
| Comp. | 57.0 | 41.5 | 1401.5/0/0 | 10° C./min -> 400° C. -> | 160.7488 |
| Ex. 19 | | | | 1° C./min -> 650° C., 7 hrs -> | |
| | | | | Cool; | |
| Comp. | 85.4 | 51.2 | 1366.0/0/0 | 10° C./min -> 500° C., 5 hrs -> | 199.6612 |
| Ex. 20 | | | | 10° C./min -> 650° C., 6.5 hrs -> | |
| | | | | Cool; | |
| Comp. | 600.0 | 360 | 7200.0/0/0 | 700 C., 4.5 hrs | 260.6773 |
| Ex. 21 | | | | | |
| Comp. | 600.0 | 360 | 7646.0/0/0 | 700 C., 3.5 hrs | 246.6964 |
| Ex. 23 | | | | | |
| Comp. | 85.4 | 51.2 | 1366.0/0/0 | 10° C./min -> 500° C., 5 hrs -> | 199.6612 |
| Ex. 26 | | | | 10° C./min -> 650° C., 6.5 hrs -> | |
| | | | | Cool; | |
| Comp. | 87.8 | 51.8 | 1363.5/0/0 | 10° C./min -> 400° C. -> | 202.0724 |
| Ex. 27 | | | | 1° C./min -> 650° C., 7 hrs -> | |
| | | | | Cool; | |
| Comp. | 600.0 | 354 | 9318.1/0/0 | 10° C./min -> 400° C. -> | 202.0724 |
| Ex. 28 | | | | 1° C./min -> 650° C., 7 hrs -> | |
| | | | | Cool; | |
| Comp. | 600.0 | 354 | 9318.1/0/0 | 10° C./min -> 400° C. -> | 202.0724 |
| Ex. 29 | | | | 1° C./min -> 650° C., 7 hrs -> | |
| | | | | Cool; | |
| Comp. | 92.2 | 44.8 | 1178.1/0/0 | 10° C./min -> 650° C., 0 hrs | 200.6528 |
| Ex. 30 | | | | hold -> Cool; | |

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. A composite fiber comprising:
a porous silicon phase comprising elemental silicon;
a porous carbon phase comprising elemental carbon;
wherein the silicon phase and the carbon phase form an intertwined network structure in the composite fiber such that each of the silicon phase and the carbon phase is interconnected and continuous throughout the composite fiber;
wherein the silicon phase comprises at least 75 percent by weight of elemental silicon in the form of silicon crystallites having an average size of 15 to 50 nm;
wherein the carbon phase comprises 20 to 60 percent by weight of the composite fiber; and
wherein the silicon phase and the carbon phase together constitute at least 50 percent by weight of the composite fiber.

2. The composite fiber of claim 1, wherein the composite fiber has a BET specific surface area of 0.1 to 45 m²/g and a pore volume of greater than 0 to 0.25 cm³/g.

3. The composite fiber of claim 1, wherein the composite fiber has an average pore size of from 5 to 80 nm.

4. The composite fiber of claim 1, wherein the composite fiber has an aspect ratio of fiber length to diameter of at least 3.

5. The composite fiber of claim 1, the silicon phase and the carbon phase together constitute at least 90 percent by weight of the composite fiber.

6. The composite fiber of claim 5, wherein the silicon phase comprises at least 90 percent by weight of elemental silicon, the silicon crystallites have an average size of 20 to 40 nm, and the carbon phase comprises 20 to 45 percent by weight of the composite fiber.

7. The composite fiber of claim 5, wherein the silicon phase comprises 75 to 90 percent by weight of elemental silicon, the silicon crystallites have an average size of 20 to 45 nm, and the carbon phase comprises 32 to 50 percent by weight of the composite fiber.

8. A method of making the composite fiber of claim 1, comprising:
forming a porous fiber template comprising one of carbon or silicon, wherein the porous fiber template comprises one of the silicon phase or the carbon phase; and
infiltrating the porous fiber template with the other of carbon or silicon to form an infiltrating phase, wherein the infiltrating phase comprises the other of the silicon phase or the carbon phase.

9. The method of claim 8, wherein the porous fiber template consists essentially of carbon.

10. The method of claim 8, wherein the porous fiber template consists essentially of silicon.

11. The method of claim 8, wherein an average pore diameter of the infiltrating phase is from 0.1 to 5 nm less than an average pore diameter of the porous fiber template.

12. The method of claim 11, wherein infiltrating the porous fiber template comprises chemical vapor deposition, physical vapor deposition, sputtering, atomic layer deposition, or pyrolysis.

13. The method of claim 11, wherein the porous fiber template comprises silicon and forming the porous fiber template comprises:
heating a silica precursor fiber in the presence of magnesium and a moderator to a temperature of about 550° C. to about 600° C., wherein the moderator is present in an amount sufficient to reach a maximum reaction temperature of at least 300° C.; and
wherein a weight ratio of the moderator to the magnesium is less than 15.

14. The method of claim 13, wherein the moderator comprises sodium chloride and the maximum temperature is maintained below 900° C.

15. The method of claim 8, further comprising reacting the composite fiber with a lithium source to form a LiₓSi alloy where x is from greater than 0 to 4.

16. An electrode active material comprising the composite fiber of claim 1.

17. An electrode comprising the electrode active material of claim 16, the electrode having a first Coulombic efficiency of at least 78% and a first cycle specific delithiation capacity of at least 1300 mAh/g.

18. The electrode of claim 17, wherein the silicon phase comprises at least 90 percent by weight of elemental silicon, the silicon crystallites have an average size of 20 to 40 nm, and the carbon phase comprises 20 to 45 percent by weight of the composite fiber; and wherein the electrode has a first cycle specific delithiation capacity of at least 1800 mAh/g.

19. The electrode of claim 17, wherein the silicon phase comprises 75 to 90 percent by weight of elemental silicon, the silicon crystallites have an average size of 20 to 45 nm, and the carbon phase comprises 32 to 50 percent by weight of the composite fiber; and wherein the electrode has a tenth cycle Coulombic efficiency of greater than 98.7%.

20. A battery comprising the electrode of claim 16.
